(19) United States
(12) Patent Application Publication
(10) Pub. No.: US 2017/0139293 A1
(43) Pub. Date: May 18, 2017

(54) LIQUID CRYSTAL PANEL AND ARRAY SUBSTRATE

(71) Applicant: Shenzhen China Star Optoelectronics Technology Co., Ltd., Shenzhen, Guangdong (CN)

(72) Inventor: Peng DU, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/759,225

(22) PCT Filed: Jun. 12, 2015
(86) PCT No.: PCT/CN2015/081302

§ 371 Date: Jul. 4, 2015

(30) Foreign Application Priority Data
May 26, 2015 (CN) 201510276532.2

(51) Int. Cl. G02F 1/1362; G02F 1/1335; G02F 1/1333; G02F 1/1368

(52) U.S. Cl. CPC G02F 1/136209; G02F 1/136286; G02F 1/1368; G02F 1/133514; G02F 1/133345; G02F 1/133512; G02F 2001/13685; G02F 2201/52; G02F 2203/01; G02F 2201/123; G02F 2202/10

(57) ABSTRACT

A liquid crystal panel and an array substrate are disclosed. The liquid crystal panel includes an array substrate, a color filter substrate and a liquid crystal layer. The array substrate includes multiple scanning lines, multiple data lines, multiple pixel units, a light-shading layer and multiple pixel units formed inside multiple pixel areas surrounded by the multiple scanning lines and the multiple data lines intersected with each other. Each pixel unit respectively includes a top-gate thin-film transistor and a pixel electrode. The light-shading layer is located right below the multiple data lines for preventing two sides of each data line from leaking light. The present invention can prevent the two sides of each data line from leaking light, increase a relative positional precision of the light-shading layer and data lines in order to further decrease a width of the light-shading layer, and increase the aperture ratio and the light transmittance ratio.

### BACKGROUND OF THE INVENTION

1. Field of the Invention

The present invention relates to a liquid crystal display technology field, and more particularly to a liquid crystal panel and an array substrate. 2. Description of Related Art

A liquid crystal display device is a main flat display device. A liquid crystal panel of the liquid crystal display device is mainly formed by an array substrate and a color filter substrate. Currently, when manufacturing a display panel, the array substrate and the color filter substrate are manufactured respectively. Then, the two substrates are aligned and adhered.

In the conventional art, an array substrate of the liquid crystal panel often generates a light-leakage phenomenon at two sides of the data line. A solution is to provide a black matrix on the color filter substrate as a light-shading structure in order to prevent two sides of the data line from leaking light. However, in the conventional art for manufacturing a liquid crystal panel, the array substrate and color filter substrate are required to be aligned. Because the array substrate and color filter substrate exist an alignment error and a distance between the array substrate and color filter substrate is farther, a width of the black matrix is usually greater than a width of the data line so that when the array substrate and color filter substrate are misaligned, a light-shading function is still working and preventing the light leakage. However, a wider width of the black matrix will impact the aperture ratio and the light transmittance ratio of the liquid crystal panel.

### SUMMARY OF THE INVENTION

The main technology problem solved by the present invention is to provide a liquid crystal panel and an array substrate in order to prevent the two sides of each data line from leaking light, increase a relative positional precision of the light-shading layer and data lines in order to further decrease a width of the light-shading layer, and increase the aperture ratio and the light transmittance ratio.

In order to solve the above technology problem, a technology solution adopted by the present invention is: a liquid crystal panel, comprising: an array substrate, including: multiple scanning lines, disposed on the array substrate; multiple data lines, disposed on the array substrate; multiple pixel units, formed inside multiple pixel areas surrounded by the multiple scanning lines and the multiple data lines intersected with each other, and each pixel unit respectively includes a top-gate thin-film transistor and a pixel electrode; and a light-shading layer located right below the multiple data lines for preventing two sides of each data line from leaking light; a color filter substrate, disposed oppositely to the array substrate; a liquid crystal layer, disposed between the array substrate and the color filter substrate; wherein, at a location for shading each data line, a width of the light-shading layer is greater than a width of the data line; wherein, the color filter substrate includes: a transparent substrate, multiple pixel regions corresponding to the pixel areas on the array substrate; and a color filter layer, including multiple color layers of a red color, a green color, and a blue color (RGB) three primary colors, and in the multiple color layers of RGB three primary colors, the multiple color layers of RGB three primary colors are disposed in corresponding pixel regions according to a sequence of RGB.

Wherein, the width of the light-shading layer is not greater than 110% of the width of the data line.

Wherein, each top-gate thin-film transistor respectively includes: the light-shading layer, disposed on a transparent substrate of the array substrate; a first insulation layer, covered on the light-shading layer; a source electrode and a drain electrode, respectively covered on the first insulation layer, and the source electrode and the drain electrode are adjacent and spaced apart; a semi-conductor layer, covered on the source electrode and the drain electrode; a second insulation layer, covered on the semi-conductor layer; and a gate electrode disposed on the second insulation layer, and located between the source electrode and the drain electrode; wherein, the semi-conductor layer forms a channel region between the source electrode and the drain electrode, and the light-shading layer is further extended below the channel region in order to shade a light-shading area.

Wherein, the gate electrode of each top-gate thin-film transistor is electrically connected with a corresponding scanning line, the source electrode of each top-gate thin-film transistor is electrically connected with a corresponding data line, and the drain electrode of each top-gate thin-film transistor is electrically connected with the pixel electrode.

Wherein, the color filter substrate further includes: a black matrix, disposed on the transparent substrate, and the black matrix includes multiple black matrix thin films, the black matrix thin films are intersected with each other in order to divide the color filter substrate into the multiple pixel regions; wherein, the multiple black matrix thin films are respectively located right above the multiple data lines, a width of the black matrix thin film is not greater than a width of the data line.

In order to solve the above technology problem, a technology solution adopted by the present invention is: a liquid crystal panel, comprising: an array substrate, including: multiple scanning lines, disposed on the array substrate; multiple data lines, disposed on the array substrate; multiple pixel units, formed inside multiple pixel areas surrounded by the multiple scanning lines and the multiple data lines intersected with each other, and each pixel unit respectively includes a top-gate thin-film transistor and a pixel electrode; and a light-shading layer located right below the multiple data lines for preventing two sides of each data line from leaking light; a color filter substrate, disposed oppositely to the array substrate; and a liquid crystal layer, disposed between the array substrate and the color filter substrate.

Wherein, at a location for shading each data line, a width of the light-shading layer is greater than a width of the data line.

Wherein, the width of the light-shading layer is not greater than 110% of the width of the data line.

Wherein, each top-gate thin-film transistor respectively includes: the light-shading layer, disposed on a transparent substrate of the array substrate; a first insulation layer, covered on the light-shading layer; a source electrode and a drain electrode, respectively covered on the first insulation layer, and the source electrode and the drain electrode are adjacent and spaced apart; a semi-conductor layer, covered on the source electrode and the drain electrode; a second insulation layer, covered on the semi-conductor layer; and a gate electrode disposed on the second insulation layer, and located between the source electrode and the drain electrode; wherein, the semi-conductor layer forms a channel region between the source electrode and the drain electrode, and the light-shading layer is further extended below the channel region in order to shade a light-shading area.

Wherein, the gate electrode of each top-gate thin-film transistor is electrically connected with a corresponding scanning line, the source electrode of each top-gate thin-film transistor is electrically connected with a corresponding data line, and the drain electrode of each top-gate thin-film transistor is electrically connected with the pixel electrode.

Wherein, the color filter substrate includes: a transparent substrate, multiple pixel regions corresponding to the pixel areas on the array substrate; and a color filter layer, including multiple color layers of a red color, a green color, and a blue color (RGB) three primary colors, and in the multiple color layers of RGB three primary colors, the multiple color layers of RGB three primary colors are disposed in corresponding pixel regions according to a sequence of RGB.

Wherein, the color filter substrate further includes: a black matrix, disposed on the transparent substrate, and the black matrix includes multiple black matrix thin films, the black matrix thin films are intersected with each other in order to divide the color filter substrate into the multiple pixel regions; wherein, the multiple black matrix thin films are respectively located right above the multiple data lines, a width of the black matrix thin film is not greater than a width of the data line.

In order to solve the above technology problem, a technology solution adopted by the present invention is: an array substrate, comprising: multiple scanning lines, disposed on the array substrate; multiple data lines, disposed on the array substrate; multiple pixel units, formed inside multiple pixel areas surrounded by the multiple scanning lines and the multiple data lines intersected with each other, and each pixel unit respectively includes a top-gate thin-film transistor and a pixel electrode; and a light-shading layer located right below the multiple data lines for preventing two sides of each data line from leaking light.

Wherein, at a location for shading each data line, a width of the light-shading layer is greater than a width of the data line.

Wherein, each top-gate thin-film transistor respectively includes: the light-shading layer, disposed on a transparent substrate of the array substrate; a first insulation layer, covered on the light-shading layer; a source electrode and a drain electrode, respectively covered on the first insulation layer, and the source electrode and the drain electrode are adjacent and spaced apart; a semi-conductor layer, covered on the source electrode and the drain electrode; a second insulation layer, covered on the semi-conductor layer; and a gate electrode disposed on the second insulation layer, and located between the source electrode and the drain electrode; wherein, the semi-conductor layer forms a channel region between the source electrode and the drain electrode, and the light-shading layer is further extended below the channel region in order to shade a light-shading area.

The beneficial effects of the present invention are: comparing with the conventional art, a light-shading layer is disposed on an array substrate of a liquid crystal panel, and the light-shading layer is located right below the multiple data lines in order to shade the multiple data lines so as to prevent two sides of the data line from leaking light. Because the light-shading layer and the data lines are all located on the array substrate, positions of the light-shading layer and the data lines are fixed, a relative positional precision is high and an alignment error will not be generated. Accordingly, a width of the light-shading layer can be smaller. At the same time, because the light-shading layer and the data lines are all located on the array substrate, a distance between the light-shading layer and the data lines is shorter so that a width of the light-shading layer can be further decreased. Because the width of the light-shading layer is smaller, the aperture ratio and the light transmittance ratio of the liquid crystal panel can be increased.

### BRIEF DESCRIPTION OF THE DRAWINGS

FIG. 1 is a schematic diagram of an array substrate of a liquid crystal panel according to an embodiment of the present invention;

FIG. 2 is a cross-sectional view of the liquid crystal panel at A-A line shown in FIG. 1;

FIG. 3 is a cross-sectional view of the array substrate at B-B line shown in FIG. 1;

FIG. 4 is a schematic diagram of an array substrate according to an embodiment of the present invention;

FIG. 5 is a cross-sectional view at A-A line shown in FIG. 4; and

FIG. 6 is a cross-sectional view at B-B line shown in FIG. 4.

### DETAILED DESCRIPTION OF THE PREFERRED EMBODIMENT

The following content combines figures and embodiments for detail description of the present invention.

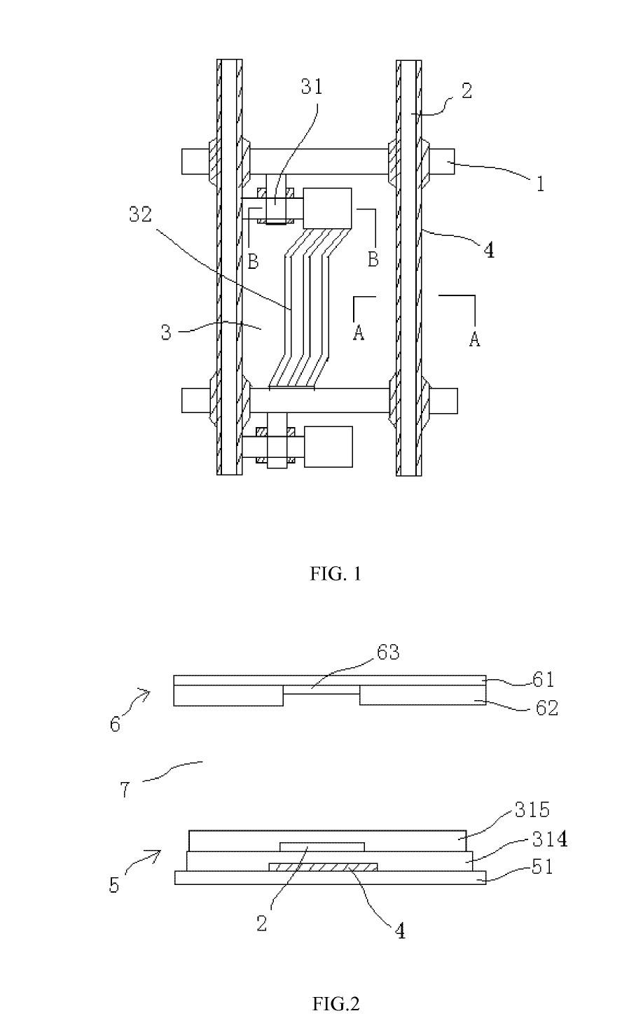

With reference to FIG. 1 and FIG. 2, an embodiment of the present invention provides a liquid crystal panel. The liquid crystal panel includes an array substrate 5, a color filter substrate 6 and a liquid crystal layer 7. The array substrate 5 and the color filter substrate 6 are disposed oppositely. The liquid crystal layer 7 is packaged between the array substrate 5 and the color filter substrate 6.

Wherein, the array substrate 5 includes multiple scanning lines 1, multiple data lines 2, multiple pixel units 3 and a light-shading layer 4. The multiple scanning lines 1 are disposed in parallel with each other. The multiple data lines 2 are disposed in parallel with each other. The multiple scanning lines 1 and the multiple data lines 2 are intersected with each other so as to divide the array substrate 5 into multiple pixel areas. The multiple pixel units 3 are respectively formed in the multiple pixel areas surrounded by the multiple scanning lines 1 and the multiple data lines 2. Each of the multiple pixel units 3 includes a top-gate thin-film transistor 31 and a pixel electrode 32. A gate electrode of the top-gate thin-film transistor 31 is disposed above a source electrode and a drain electrode. The top-gate thin-film transistor 31 is connected with the scanning line 1, the data line 2 and the pixel electrode 32. Through a scanning signal of the scanning line 1 to control the top-gate thin-film transistor 31 such that a data signal of the data lines 2 is sent to the pixel electrode 32 and the pixel electrode 32 generates an electric field to deflect liquid crystal molecules.

The light-shading layer 4 is disposed right below the multiple data lines 2. That is, right below each of the multiple data lines 2, the light-shading layer 4 is provided. The light-shading layer 4 is used to prevent two sides of each data line 2 from leaking light. Because a backlight is emitted along a direction from the light-shading layer 4 to the data line 2, disposing the light-shading layer 4 below the data line 2 can shade the light emitted to the data line 2 in order to prevent the two sides of each data line 2 from generating a light leakage phenomenon. Generally, the light-shading layer 4 is only required to shade the data line 2, and an area of the light-shading layer is not allowed to be too large. A too large area of the light-shading layer 4 will affect the aperture ratio and the light transmittance ratio. The light- shading layer can be a metal light-shading layer such as a molybdenum film, an aluminum film, a chromium film, a copper film, or an alloy film including at least two of molybdenum, aluminum, chromium, and copper.

In the embodiment of the present invention, a light-shading layer 4 is disposed on the array substrate 5, and the light-shading layer 4 is located right below the multiple data lines 2 so as to shade light for the multiple data lines 2 in order to prevent the two sides of each data line 2 from generating a light leakage phenomenon. Because the light-shading layer 4 and the data lines 2 are all located on the array substrate 5, positions of the light-shading layer 4 and the data lines 2 are fixed, a relative positional precision is high and an alignment error will not be generated. Accordingly, a width of the light-shading layer 4 can be smaller. At the same time, because the light-shading layer 4 and the data lines 2 are all located on the array substrate 5, a distance between the light-shading layer 4 and the data lines 2 is shorter so that a width of the light-shading layer 4 can be further decreased. Because the width of the light-shading layer 4 is smaller, the aperture ratio and the light transmittance ratio of the liquid crystal panel can be increased.

Wherein, at a location for shading each data line 2, a width of the light-shading layer 4 is greater than a width of each data line 2.

In the present embodiment, an arrangement pattern of the light-shading layer 4 and an arrangement pattern of the data lines 2 are the same. That is, the light-shading layer 4 is disposed below the data lines 2 along a distribution way of the data lines 2 so that the light-shading layer 4 can exactly shade the data lines 2 without affecting the other areas. Because a certain distance is existed between the light-shading layer 4 and the data lines 2, at a location for shading each data line 2, the width of the light-shading layer 4 has to be greater than the width of each data line 2. A same location means a location of the light-shading layer 4 which is corresponding to the data lines 2, and at the same location, the width of the light-shading layer 4 is slightly greater than the width of each data line 2. Specifically, the light-shading layer 4 respectively extends a width at two sides of each data line 2. The width of the light-shading layer 4 is less than a width of a black matrix disposed on a color filter substrate for shading light in the conventional art.

Wherein, the width of the light-shading layer is not greater than 110% of the width of the data line 2. Specifically, firstly, an original width of the light-shading layer 4 can be disposed to be the same as the width of the data line 2. Then, the original width of the light-shading layer 4 respectively extends a width not greater than 5% of the original width at two sides of the data line 2. In another embodiment, a width of the light-shading layer 4 is not greater than 105% of a width of the data line 2 or 115% of a width of the data line 2.

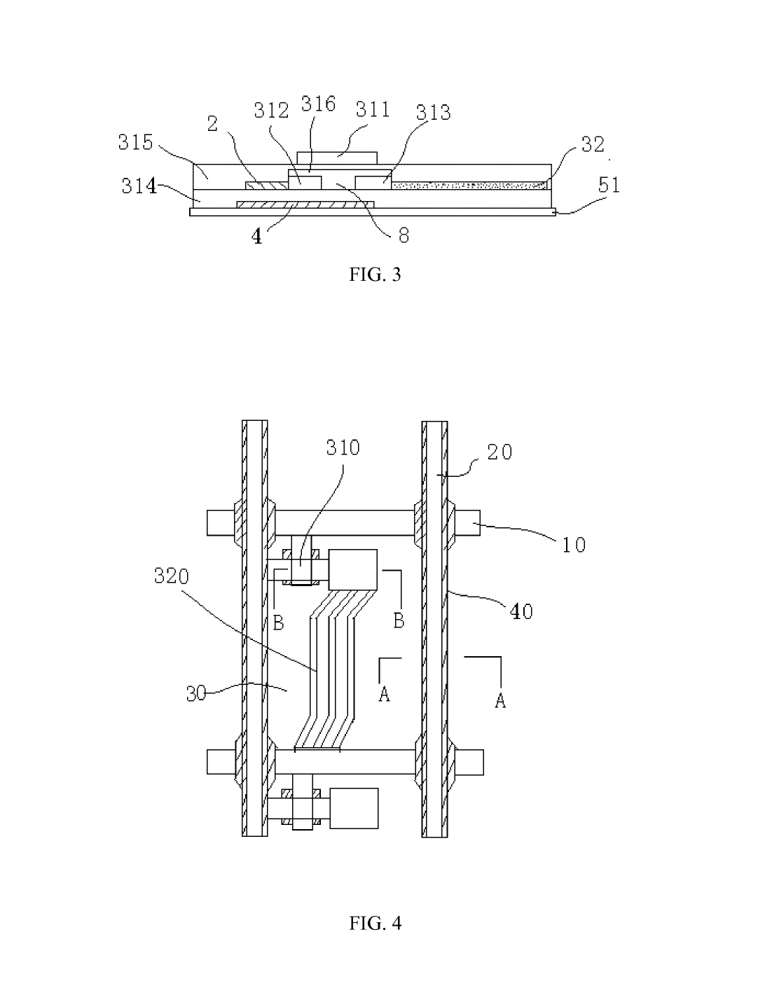

As shown in FIG. 3, wherein, each top-gate thin-film transistor 31 respectively includes a light-shading layer 4, a first insulation layer 314, a source electrode 312, a drain electrode 313, a semi-conductor layer 316, a second insulation layer 315, and a gate electrode 311. Wherein, the light-shading layer 4 is disposed on a transparent substrate 51 of an array substrate 5. The transparent substrate 51 is a base substrate of the array substrate 5, and the transparent substrate 51 can be a glass substrate. The first insulation layer 314 is covered on the light-shielding layer 4. The source electrode 312 and the drain electrode 313 are respectively covered on the first insulation layer 314. The source electrode 312 and the drain electrode 313 are adjacent and spaced apart. The semi-conductor layer 316 is covered on the source electrode 312 and the drain electrode 313. The semi-conductor layer 316 is made of amorphous silicon. The second insulation layer 315 is covered on the semi-conductor layer 316. The gate electrode 311 is disposed on the second insulation layer 315, and located between the source electrode 312 and the drain electrode 313. Wherein, in the present embodiment, the first insulation layer 314 and the second insulation layer 315 can be silicon oxide or silicon nitride and so on.

Wherein, the semi-conductor layer 316 forms a channel region 8 between the source electrode 312 and the drain electrode 313. The light-shading layer 4 is further extended below the channel region 8 in order to shade a light-shading area. The semi-conductor layer 316 covers on the source electrode 312, the drain electrode 313 and a region between the source electrode 312 and the drain electrode 313. Besides, the channel region is formed between the source electrode 312 and the drain electrode 313.

Generally, on the array substrate 5, a light-shading layer 4 is disposed to shade light for the channel region 8 between the source electrode 312 and the drain electrode 313. In the present embodiment, the light-shading layer 4 is extended and expanded so as to shade light for the data lines 2 at the same time. As a result, a light leakage phenomenon at two sides of each data line 2 is prevented. Besides, a manufacturing process is simplified.

Wherein, a gate electrode 311 of each top-gate thin-film transistor 31 is electrically connected with a corresponding scanning line 1, the source electrode 312 is electrically connected with a corresponding data line 2, and the drain electrode 313 is electrically connected with a pixel electrode 32. In the present embodiment, the data line 2 and the pixel electrode 32 are disposed between the first insulation layer 314 and the second insulation layer 315.

In the present embodiment and related figures, a relative position relationship of the light-shading layer 4, the gate electrode 313, the drain electrode 313, the source electrode 312 and the data lines 2 is schematically shown. Therefore, the present embodiment and related figures are not used to limit a specific structure of the array substrate 5. The method for specifically manufacturing the array substrate 5 is a common technology of the liquid crystal panel in the present technology field.

Wherein, the color filter substrate 6 includes a transparent substrate 61 and a color filter layer 62. The transparent substrate 61 includes multiple pixel regions corresponding to the pixel areas on the array substrate 5. The color filter layer 62 includes multiple color layers of a red color, a green color, and a blue color (RGB) three primary colors. In the multiple color layers of RGB three primary colors, the multiple color layers of RGB three primary colors are disposed in corresponding pixel regions according to a sequence of RGB.

Comparing with the conventional color filter substrate, in the present embodiment, a black matrix is not disposed on the color filter substrate 6, and only disposing the light-shading layer 4 on the array substrate 5 in order to prevent two sides of the data line 2 from leaking light. At the same time, because the color filter substrate does not provide with the black matrix, the aperture ratio and the light transmittance ratio of the liquid crystal panel can be increased.

Wherein, in another embodiment of the present invention, the color filter substrate 6 further includes a black matrix 63. The black matrix 63 is disposed on the transparent substrate 61, and the black matrix 63 includes multiple black matrix thin films. The black matrix thin films are intersected with each other in order to divide the color filter substrate 6 into multiple pixel regions corresponding to the pixel areas on the array substrate 5. The multiple black matrix thin films are respectively located right above the multiple data lines 2. A width of the black matrix thin film is not greater than a width of the data line 2. In the embodiment of the present invention, the black matrix 63 on the color filter substrate 6 is disposed corresponding to the data lines 2 in order to further prevent two sides of the data line 2 from leaking light. At the same time, the width of the black matrix 63 is less than or equal to the width of the data line 2. Comparing with the conventional color filter substrate, the width of the black matrix is smaller such that the affection of the aperture ratio and the light transmittance ratio of the liquid crystal panel is decreased.

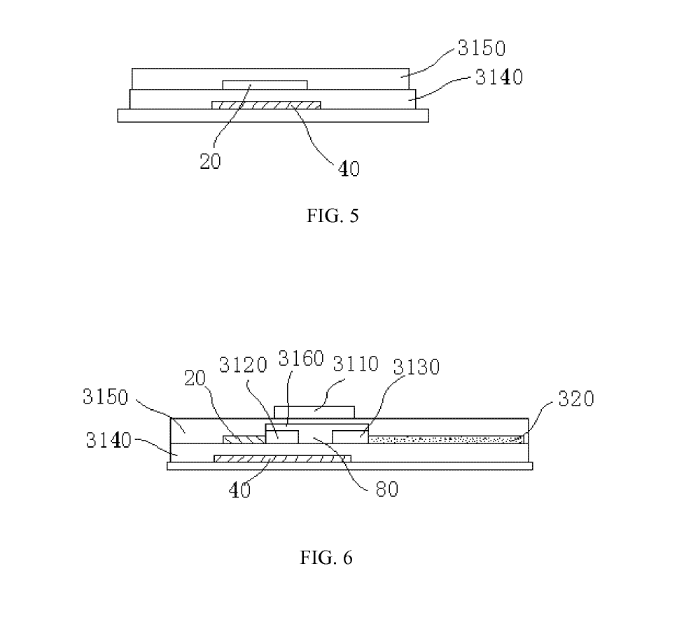

As shown in FIG. 4 and FIG. 5, another embodiment of the present invention provides an array substrate; the array substrate has a same structure as the array substrate of the liquid crystal panel in the above embodiment. Specifically, the array substrate includes multiple scanning lines 10, multiple data lines 20 and multiple pixel units 30. Wherein, the multiple pixel units 30 are formed inside multiple pixel areas surrounded by the multiple scanning lines 10 and the multiple data lines 20 intersected with each other. Each pixel unit 30 respectively includes a top-gate thin-film transistor 310 and a pixel electrode 320. The light-shading layer 40 is located right below the multiple data lines 20 in order to prevent two sides of each data line 20 from leaking light.

In the embodiment of the present invention, a light-shading layer 40 is located right below the multiple data lines 20 so as to shade light for the multiple data lines 20 in order to prevent the two sides of each data line 20 from generating a light leakage phenomenon. Because the light-shading layer 40 and the data lines 20 are all located on the array substrate, positions of the light-shading layer 40 and the data lines 20 are fixed, a relative positional precision is high and an alignment error will not be generated. Accordingly, a width of the light-shading layer 40 can be smaller. At the same time, because the light-shading layer 40 and the data lines 20 are all located on the array substrate, a distance between the light-shading layer 40 and the data lines 20 is shorter so that a width of the light-shading layer 40 can be further decreased. Because the width of the light-shading layer 40 is smaller, the aperture ratio and the light transmittance ratio of the liquid crystal panel can be increased.

Wherein, at a location for shading each data line 20, a width of the light-shading layer 40 is greater than a width of each data line 20.

As shown in FIG. 6, wherein, each top-gate thin-film transistor 310 includes a light-shading layer 40, a first insulation layer 3140, a source electrode 3120, a drain electrode 3130, a semi-conductor layer 3160, a second insulation layer 3150 and a gate electrode 3110. Wherein, the light-shading layer 40 is disposed on a transparent substrate of an array substrate. The first insulation layer 3140 is covered on the light-shielding layer 40. The source electrode 3120 and the drain electrode 3130 are respectively covered on the first insulation layer 3140. The source electrode 3120 and the drain electrode 3130 are adjacent and spaced apart. The semi-conductor layer 3160 is covered on the source electrode 3120 and the drain electrode 3130. The second insulation layer 3150 is covered on the semi-conductor layer 3160. The gate electrode 3110 is disposed on the second insulation layer 3150, and located between the source electrode 3120 and the drain electrode 3130. Wherein, the semi-conductor layer 3160 forms a channel region between the source electrode 3120 and the drain electrode 3130. The light-shading layer 40 is further extended below the channel region in order to shade a light-shading area.

The structure of the array substrate of present embodiment is the same as the array substrate of the liquid crystal panel of the above embodiment. The effects are the same. The specific detail can refer to above embodiment, no more repeating.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A liquid crystal panel, comprising:
an array substrate, including:
multiple scanning lines, disposed on the array substrate;
multiple data lines, disposed on the array substrate;
multiple pixel units, formed inside multiple pixel areas surrounded by the multiple scanning lines and the multiple data lines intersected with each other, and each pixel unit respectively includes a top-gate thin-film transistor and a pixel electrode; and
a light-shading layer located right below the multiple data lines for preventing two sides of each data line from leaking light;
a color filter substrate, disposed oppositely to the array substrate;
a liquid crystal layer, disposed between the array substrate and the color filter substrate;
wherein, at a location for shading each data line, a width of the light-shading layer is greater than a width of the data line; and
wherein, the color filter substrate includes:
a transparent substrate, multiple pixel regions corresponding to the pixel areas on the array substrate; and
a color filter layer, including multiple color layers of a red color, a green color, and a blue color (RGB) three primary colors, and in the multiple color layers of RGB three primary colors, the multiple color layers of RGB three primary colors are disposed in corresponding pixel regions according to a sequence of RGB.

2. The liquid crystal panel according to claim 1, wherein, the width of the light-shading layer is not greater than 110% of the width of the data line.

3. The liquid crystal panel according to claim 1, wherein, each top-gate thin-film transistor respectively includes:
the light-shading layer, disposed on a transparent substrate of the array substrate;
a first insulation layer, covered on the light-shading layer;
a source electrode and a drain electrode, respectively covered on the first insulation layer, and the source electrode and the drain electrode are adjacent and spaced apart;
a semi-conductor layer, covered on the source electrode and the drain electrode;
a second insulation layer, covered on the semi-conductor layer; and
a gate electrode disposed on the second insulation layer, and located between the source electrode and the drain electrode;
wherein, the semi-conductor layer forms a channel region between the source electrode and the drain electrode, and the light-shading layer is further extended below the channel region in order to shade a light-shading area.

4. The liquid crystal panel according to claim 3, wherein, the gate electrode of each top-gate thin-film transistor is electrically connected with a corresponding scanning line, the source electrode of each top-gate thin-film transistor is electrically connected with a corresponding data line, and the drain electrode of each top-gate thin-film transistor is electrically connected with the pixel electrode.

5. The liquid crystal panel according to claim 1, wherein, the color filter substrate further includes:
a black matrix, disposed on the transparent substrate, and the black matrix includes multiple black matrix thin films, the black matrix thin films are intersected with each other in order to divide the color filter substrate into the multiple pixel regions;
wherein, the multiple black matrix thin films are respectively located right above the multiple data lines, a width of the black matrix thin film is not greater than a width of the data line.

6. A liquid crystal panel, comprising:
an array substrate, including:
multiple scanning lines, disposed on the array substrate;
multiple data lines, disposed on the array substrate;
multiple pixel units, formed inside multiple pixel areas surrounded by the multiple scanning lines and the multiple data lines intersected with each other, and each pixel unit respectively includes a top-gate thin-film transistor and a pixel electrode; and
a light-shading layer located right below the multiple data lines for preventing two sides of each data line from leaking light;
a color filter substrate, disposed oppositely to the array substrate; and
a liquid crystal layer, disposed between the array substrate and the color filter substrate.

7. The liquid crystal panel according to claim 6, wherein, at a location for shading each data line, a width of the light-shading layer is greater than a width of the data line.

8. The liquid crystal panel according to claim 7, wherein, the width of the light-shading layer is not greater than 110% of the width of the data line.

9. The liquid crystal panel according to claim 6, wherein, each top-gate thin-film transistor respectively includes:
the light-shading layer, disposed on a transparent substrate of the array substrate;
a first insulation layer, covered on the light-shading layer;
a source electrode and a drain electrode, respectively covered on the first insulation layer, and the source electrode and the drain electrode are adjacent and spaced apart;
a semi-conductor layer, covered on the source electrode and the drain electrode;
a second insulation layer, covered on the semi-conductor layer; and
a gate electrode disposed on the second insulation layer, and located between the source electrode and the drain electrode;
wherein, the semi-conductor layer forms a channel region between the source electrode and the drain electrode, and the light-shading layer is further extended below the channel region in order to shade a light-shading area.

10. The liquid crystal panel according to claim 9, wherein, the gate electrode of each top-gate thin-film transistor is electrically connected with a corresponding scanning line, the source electrode of each top-gate thin-film transistor is electrically connected with a corresponding data line, and the drain electrode of each top-gate thin-film transistor is electrically connected with the pixel electrode.

11. The liquid crystal panel according to claim 6, wherein, the color filter substrate includes:
a transparent substrate, multiple pixel regions corresponding to the pixel areas on the array substrate; and
a color filter layer, including multiple color layers of a red color, a green color, and a blue color (RGB) three primary colors, and in the multiple color layers of RGB three primary colors, the multiple color layers of RGB three primary colors are disposed in corresponding pixel regions according to a sequence of RGB.

12. The liquid crystal panel according to claim 11, wherein, the color filter substrate further includes:
a black matrix, disposed on the transparent substrate, and the black matrix includes multiple black matrix thin films, the black matrix thin films are intersected with each other in order to divide the color filter substrate into the multiple pixel regions;
wherein, the multiple black matrix thin films are respectively located right above the multiple data lines, a width of the black matrix thin film is not greater than a width of the data line.

13. An array substrate, comprising:
multiple scanning lines, disposed on the array substrate;
multiple data lines, disposed on the array substrate;
multiple pixel units, formed inside multiple pixel areas surrounded by the multiple scanning lines and the multiple data lines intersected with each other, and each pixel unit respectively includes a top-gate thin-film transistor and a pixel electrode; and
a light-shading layer located right below the multiple data lines for preventing two sides of each data line from leaking light.

14. The array substrate according to claim 13, wherein, at a location for shading each data line, a width of the light-shading layer is greater than a width of the data line.

15. The array substrate according to claim 13, wherein, each top-gate thin-film transistor respectively includes:
the light-shading layer, disposed on a transparent substrate of the array substrate;
a first insulation layer, covered on the light-shading layer;
a source electrode and a drain electrode, respectively covered on the first insulation layer, and the source electrode and the drain electrode are adjacent and spaced apart;
a semi-conductor layer, covered on the source electrode and the drain electrode;
a second insulation layer, covered on the semi-conductor layer; and
a gate electrode disposed on the second insulation layer, and located between the source electrode and the drain electrode;
wherein, the semi-conductor layer forms a channel region between the source electrode and the drain electrode, and the light-shading layer is further extended below the channel region in order to shade a light-shading area.
